(19) United States
(12) Patent Application Publication
(10) Pub. No.: US 2014/0061107 A1
(43) Pub. Date: Mar. 6, 2014

(54) DEWATERING SYSTEM

(71) Applicant: Don M. Buckner, Okahumpka, FL (US)

(72) Inventor: Don M. Buckner, Okahumpka, FL (US)

(21) Appl. No.: 14/034,705

(22) Filed: Sep. 24, 2013

Related U.S. Application Data
(63) Continuation-in-part of application No. 13/602,403, filed on Sep. 4, 2012, now Pat. No. 8,584,795.

(51) Int. Cl. B01D 35/20

(52) U.S. Cl. CPC B01D 35/20
USPC 210/121; 210/388; 210/486; 210/416.1

(57) ABSTRACT

A dewatering system is disclosed. In a particular embodiment, the system includes a debris tank configured to receive a slurry through an inlet and a dewatering filter installed in the debris tank. In addition, the system includes a bar screen forming a curvilinear surface of the dewatering filter, where the bar screen is configured to prevent sediment from passing through and into an interior space of the dewatering filter. A first end of the dewatering filter is in communication with a discharge port to remove filtered liquid from an interior of the debris tank, and a vibratory device is configured to shake the dewatering filter to remove sediment from an exterior surface of the dewatering filter.

### CROSS REFERENCE TO RELATED APPLICATIONS

This application is a continuation-in-part of U.S. patent application Ser. No. 13/602,403 filed Sep. 4, 2012.

### FIELD

The present invention relates in general to a dewatering system.

### DESCRIPTION OF RELATED ART

Industrial vacuum equipment has dozens of wet and dry uses such as locating underground utilities (potholing), hydro excavation, air excavation and vacuum excavation. In addition, the equipment can be used for directional drilling slurry removal, industrial clean-up, waste clean-up, lateral and storm drain clean-out, oil spill clean-up and other natural disaster clean-up applications, signs and headstone setting, for example. The vacuum systems may be mounted to a truck or trailer and are typically powered by gas or diesel engines. Both the wet and dry material is vacuumed up and stored in a debris tank. From there, the material may be hauled away and disposed of offsite or the tank may be emptied at the site.

The industrial vacuum equipment utilizes a high volume induced flow through a filter chamber to carry water and debris into the chamber, where they are separated. The dewatering process includes filtering out the debris from the water or other fluids and removing for disposal. Truck mounted vacuum equipment may utilize different stages of filtration for the debris and water. For example, the incoming flow may be directed into a settling chamber allowing the debris to settle out of the water. Filters may also be used to help quickly separate the water from the debris. A problem often encountered with the filters is that they can become clogged as the debris collects on the filters and the flow path is restricted causing the reduction in suction power of the vacuum equipment. In addition, removing the debris from the filters is time consuming and reduces the efficiency of the dewatering process.

Therefore, a need exists in the art for a dewatering system that resists clogging while remaining efficient in separating the water from the debris and is easy to maintain. However, in view of the prior art at the time the present invention was made, it was not obvious to those of ordinary skill in the pertinent art how the identified needs could be fulfilled.

### SUMMARY

In a particular embodiment, a dewatering system is disclosed. The system includes a debris tank configured to receive a slurry through an inlet, a dewatering filter installed in the debris tank, and a bar screen forming a curvilinear surface of the dewatering filter, where the curvilinear bar screen is configured to prevent debris from passing through and into an interior space of the dewatering filter. A first end of the dewatering filter is in communication with a discharge port to remove filtered liquid from the interior space of the dewatering filter. In addition, a vibratory device is secured to the dewatering filter and configured to shake the dewatering filter to remove debris and clean an exterior surface of the dewatering filter.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is an elevational view of a particular embodiment a dewatering filter of a dewatering system;

FIG. 2 is a top view of the dewatering filter taken in the direction of line 2-2 of FIG. 1;

FIG. 3 is a cross-sectional elevational view of the dewatering filter taken in the direction of line 2-2 of FIG. 3; and

FIG. 4 is a partial sectional view of the dewatering system with the dewatering filter installed within a debris tank.

### DETAILED DESCRIPTION

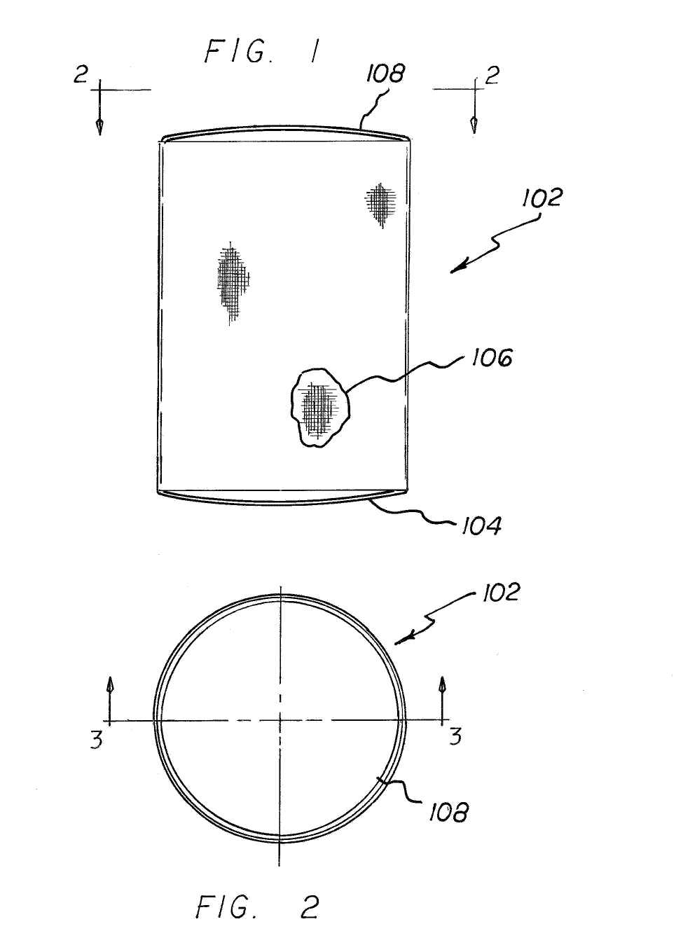

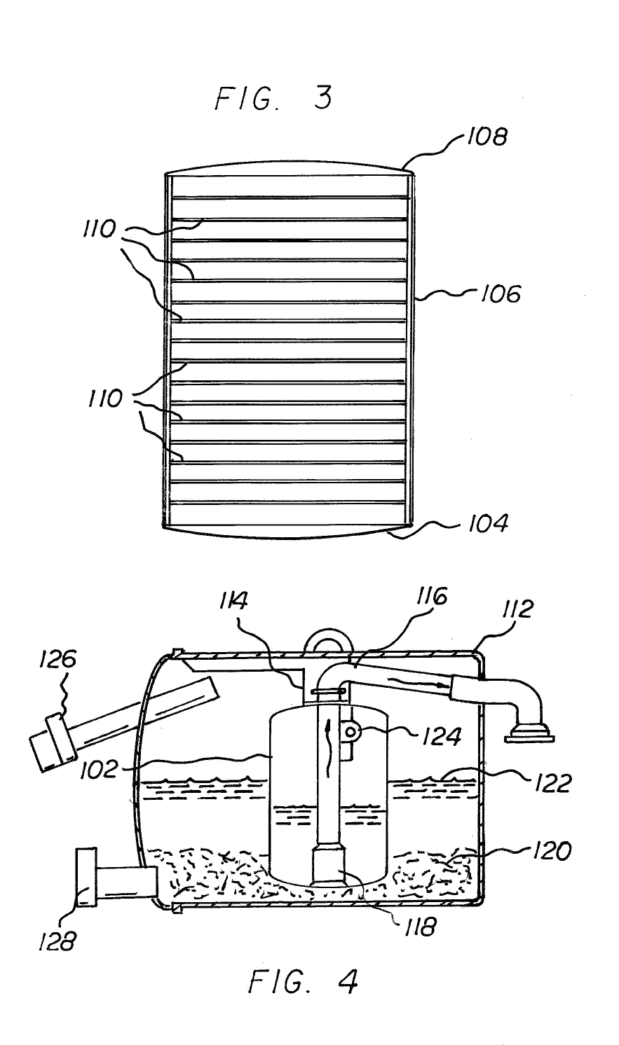

Referring now to FIGS. 1-2, a dewatering filter 102 is disclosed that is generally cylindrical in shape. One end of the dewatering filter 102, for example the bottom end 104, may be sealed so that liquids flow through to the interior of the dewatering filter 102 and out through the opposing top end 108 of the dewatering filter 102 that is open. Alternatively, the top end 108 may be sealed and the bottom end 104 of the dewatering filter may be open. The dewatering filter 102 includes a curvilinear bar screen 106 that filters debris from the liquids.

The dewatering filter 102 includes a plurality of structural hoops 110 that are parallel to one another in addition to the top and bottom ends 108, 104 of the dewatering filter 102. The curvilinear bar screen 106 overlays and covers the hoops 110. The curvilinear bar screen 106 includes a plurality of tightly spaced elements to act as a screen that is sized to allow liquid to pass and to prevent debris from flowing through to the interior of the dewatering filter 102. For example, the spacing between the tightly spaced elements of the curvilinear bar screen 106 may be approximately 4/1000ths of an inch. In addition, the dewatering filter 102 is secured to a vibration device that imparts a shaking type motion that causes particulates to shake loose from the curvilinear bar screen 106. This shaking type motion assists in keeping the dewatering filter 102 relatively clean and operating at high efficiency without having to stop and backwash the dewatering filter 102.

Referring now to FIG. 4, the dewatering filter 102 is installed in a debris tank 112 that may be generally cylindrical in shape. Alternatively, the debris tank 112 may be rectangular or any other shape. The debris tank 112 is also adapted to be mounted on and attached to a truck or trailer. The interior of the debris tank 112 is configured to collect and store a slurry of debris 120 and liquid 122. The debris tank 112 includes an inlet port 126 that is mounted to a front end of the debris tank 112. The inlet port 126 may include quick clamp type adapters for securing a length of flexible hose (not shown) to enable a worker to apply suction to remove the slurry of debris and water from a job site using the hose. An outlet port 128 is also disposed on the front end of the debris tank 112. The outlet port 128 may be used to empty the debris tank 112, where the outlet port 128 is generally located proximate a lower surface of the debris tank 112 so that the contents of the debris tank 112 may be removed by gravity flow.

The debris tank 112 is in communication with an external blower or pump (not shown) that is used to provide the vacuum or suction to the debris tank 112. A substantially enclosed float ball housing (not shown for clarity) may be disposed within the debris tank 112 and proximate an upper surface that allows liquid 122 (e.g., water) to enter the housing. The float ball housing is adapted to prevent water 122 from exiting the debris tank 112 and entering the blower or pump assembly and otherwise indicates when the debris tank 112 is full. A generally spherically shaped float within the float ball housing may be adapted to float on top of the liquid 122 in the debris tank 112 and rises with the level of liquid 122 within the debris tank 112. The float may be sized and configured to cover a circular aperture between a suction port and interior of the debris tank 112 when the float reaches the top of the housing, which stops the suction. Once the float has stopped the suction, removal of the liquid 122 from the debris tank 112 through a decanting process is desirable so that additional slurry may be vacuumed into the debris tank 112.

In operation, the debris tank 112 is filled with the slurry of liquid 122 and debris 120 using suction. As the debris tank 112 is filled, the liquid 122 may be removed from the debris tank 112 and returned to the site or otherwise disposed. This allows for filling the debris tank 112 with additional slurry as the volume of the liquid 122 is removed. Accordingly, the dewatering filter 102 is installed inside the debris tank 112 that is used during the decanting process to remove liquids 122 from the debris tank 112 while sediment and debris 120 remain in the debris tank 112. In a particular embodiment, a submersible pump 118 is within the dewatering filter 102 and is used to pump the liquid 122 out through a discharge port 114 and discharge hose 116 to expel the liquid 122 from the debris tank 102.

As explained above, the dewatering filter 102 includes a closed bottom end 104 and an exposed filter surface and sidewall that is the curvilinear bar screen 106. The dewatering filter 102 is orientated such that the liquid flow is radially inwardly with the filtered particulate material (i.e., debris 120) being trapped on the outer surface of the dewatering filter 102, which is the curvilinear bar screen 106.

When the blower is operating during the vacuum process, an induced draft is created through the debris tank 112 which draws air carrying liquid 122 and debris 120 through the inlet port 126 and into the debris tank 112. As the liquid 122 and debris 120 enters the debris tank 112 there is an immediate drop in air velocity, which causes the heavier and larger particles and objects to fall to the bottom of the debris tank 112. The particulate-laden air continues to flow in a forward direction through the debris tank 112. Most of the heavier and larger materials entrained in the air flow are removed in the debris tank 112. Thus, the air exiting the debris tank 112 and entering an exterior air filter chamber (not shown) generally contains smaller particulate materials. Additional gravity settling occurs in the debris tank 112 as the debris 120 collects on the floor of the debris tank 112 for eventual discharge through the outlet port 128 or by opening the front end of the debris tank 112 and dumping.

As the decanting process proceeds, the dewatering filter 102 may become increasingly saturated with retained particulate material and the dewatering filter 102 must be periodically cleaned. Backwashing the dewatering filter 102 results in the shutdown of the system and temporarily removes the system's filtering capacity. This is disruptive and requires a large air supply to provide a pulse or jet of compressed air adequate to clean the dewatering filter 102 at one time. Accordingly, a vibratory device 124 of the present system is secured to the dewatering filter 102 that continually, or periodically, shakes the dewatering filter 102 to dislodge particulates and debris from the curvilinear bar screen 106 so that the system does not have to be shut down for routine backwashing. Thus, the system can operate longer between backwashing the dewatering filter 102, which results in less disruptions and higher efficiency in the operation of the system.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features.

What is claimed is:

1. A dewatering system, the system comprising:
a debris tank configured to receive a slurry through an inlet port;
a dewatering filter installed in the debris tank;
a curvilinear bar screen forming a sidewall of the dewatering filter, wherein the curvilinear screen is configured to prevent debris from passing through and into an interior space of the dewatering filter;
a discharge port of the debris tank in communication with the interior space of the dewatering filter to remove liquid from the debris tank; and
a vibratory device secured to the dewatering filter.

2. The system of claim 1, wherein the curvilinear bar screen further comprising a plurality of parallel elements, wherein each parallel element is spaced substantially 4/1000ths inch from an adjacent parallel element.

3. The system of claim 2, further comprising:
a float ball housing proximate to an upper surface of an interior of the debris tank; and
a float inside the float ball housing interposed between an interior of the debris tank and configured to rise with a level of liquid inside the debris tank.

4. The system of claim 3, wherein the vibratory device is configured to shake the dewatering filter to remove debris from an exterior surface of the dewatering filter.

5. The system of claim 4, wherein the debris tank further comprising a front end that is configured to open to dump contents of the debris tank.

6. The system of claim 5, wherein the debris tank further comprising a suction port in communication with a blower that provides suction to the debris tank.

7. The system of claim 6, wherein the float is sized to cover a circular aperture between the suction port and an interior of the debris tank when the float rises to the top of the float ball housing.

8. The system of claim 7, further comprising a submersible pump in communication with the interior space of the dewatering filter and the discharge port to remove the liquid from the debris tank.

9. The system of claim 8, wherein the submersible pump is configured to reverse flow direction to backwash the dewatering filter.

10. A dewatering system, the system comprising:
a debris tank configured to receive a slurry through an inlet port;
a curvilinear bar screen installed in the debris tank, wherein the curvilinear bar screen further comprising a plurality of parallel elements spaced substantially 4/1000ths inch from an adjacent parallel element; and
a vibratory device in communication with the curvilinear bar screen.

11. A dewatering system, the system comprising:
a dewatering filter configured to be installed in a debris tank; and
a curvilinear bar screen forming a sidewall of the dewatering filter, wherein the curvilinear bar screen further comprising a plurality of parallel elements spaced substantially 4/1000ths inch from an adjacent parallel element.

12. The system of claim 11, further comprising a submersible pump within an interior space of the dewatering filter.

13. The system of claim 12, further comprising a vibratory device secured to the dewatering filter and configured to shake the dewatering filter to remove debris from the curvilinear bar screen.
